(19) United States
(12) Patent Application Publication
(10) Pub. No.: US 2026/0237699 A1
(43) Pub. Date: Aug. 13, 2026

(54) METHOD FOR OPERATING AN AIR SYSTEM, AND CONTROL UNIT

(71) Applicant: Robert Bosch GmbH, Stuttgart (DE)

(72) Inventors: Bilge Manga, Leonberg (DE); Gregory Rewers, Schwieberdingen (DE); Michael Schenk, Ludwigsburg (DE); Pascal Woerner, Korntal-Muenchingen (DE)

(21) Appl. No.: 19/156,965

(22) PCT Filed: Feb. 2, 2024
(86) PCT No.: PCT/EP2024/052569

§ 371 Date: Aug. 15, 2025

(30) Foreign Application Priority Data
Feb. 15, 2023 (DE) 10 2023 201 298.7

(51) Int. Cl. H01M 8/0438; H01M 8/0432; H01M 8/04492; H01M 8/04664; H01M 8/04992; H01M 8/0662

(52) U.S. Cl. CPC H01M 8/04432; H01M 8/0432; H01M 8/04425; H01M 8/04492; H01M 8/04686; H01M 8/04992; H01M 8/0687

(57) ABSTRACT

The invention relates to a method for operating an air system (1) for supplying oxygen to at least one fuel cell, wherein the air system (1) comprises an air path (2) having an integrated air filter (3) and an integrated air compressor (4), and wherein ambient air is drawn in by means of the air compressor (4), purified by means of the air filter (3), and compressed by means of the air compressor (4) before being fed as an oxygen source to the fuel cell. According to the invention, a diagnosis of the air filter (4) is carried out during the operation of the air system (1) and is used for
detecting excessively high loading of the air filter (3),
determining the degree of loading of the air filter (3),
detecting unauthorized removal of the air filter (3),
detecting a leak in the air path (2) upstream of the air compressor (4), and/or
detecting a hose collapse,
wherein the present pressure difference (Δp) across the air filter (3) is ascertained, and the loading of the air filter (3) is inferred from the present pressure difference (Δp).

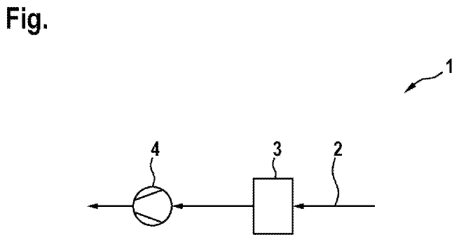

The invention also relates to a control unit for carrying out steps of the method.

### BACKGROUND

The invention relates to a method for operating an air system. Furthermore, the invention relates to a control unit, which is configured so as to carry out steps of the method.

The preferred area of application is mobile fuel cell systems, in particular mobile fuel cell systems and/or fuel cell vehicles.

A fuel cells is an electrochemical energy converter which converts hydrogen and oxygen into water, electrical energy, and heat. In practice, a large number of fuel cells are connected to form a fuel cell stack in order to increase the electrical output. In addition, multiple fuel cell stacks or fuel cell systems can be interconnected.

The hydrogen required for the electrochemical reaction is typically stored in a tank or tank system. The further oxygen required is supplied in the form of air taken from the surroundings. Due to the fact that the supplied air must be very clean, it is previously purified with the aid of an air filter. Over time, the air filter can become clogged by the particles contained in the ambient air, so that the filtering function is compromised. That is to say, the air supplied to the fuel cells can no longer be sufficiently freed of chemicals and particles, thereby promoting degradation of the fuel cells. Further components of the fuel cell system can also be damaged. With increasing loading of the air filter, the air compressor must do more work so that the fuel cells may additionally be under-supplied with oxygen.

The problem addressed by the present invention is to detect a clogged air filter in order to replace it before the aforementioned disadvantages arise.

To solve this problem, the method according to the disclosure is proposed. Advantageous embodiments can be found in the dependent claims. In addition, a control unit for carrying out steps of the method is specified.

### SUMMARY

A method for operating an air system is proposed, via which at least one fuel cell is supplied with oxygen. To this end, the air system comprises an air path having an integrated air filter and an integrated air compressor. During the operation of the air system, ambient air is drawn in by means of the air compressor, purified by means of the air filter, and compressed by means of the air compressor before being fed to the fuel cell as an oxygen supplier. According to the invention, a diagnosis of the air filter is carried out during the operation of the air system and is used for
detecting excessively high loading of the air filter,
determining the degree of loading of the air filter,
detecting unauthorized removal of the air filter,
detecting a leak in the air path upstream of the air compressor, and/or
detecting a hose collapse,
   wherein the present pressure difference Δp across the air filter is ascertained, and the loading of the air filter is inferred from the present pressure difference Δp.

The method is based on the finding that the pressure difference Δp across the air filter is dependent on the respective loading state of the air filter, so that the pressure difference can be used in order to infer the loading state. Knowing the loading state, a disruptive clogging of the air filter can be anticipated, and the air filter can be replaced in a timely manner. In the case of a mobile fuel cell system or a fuel cell vehicle, a workshop can be visited for this purpose. The replacement of the air filter prevents a shutdown of the air system and/or the fuel cell system due to malfunctions caused by clogging of the air filter. The degree of loading can also be determined based on the pressure drop across the air filter.

The proposed method can further be used in order to detect an unauthorized filter removal and/or a leak in the air path upstream of the air compressor. Upon detection of unauthorized filter removal and/or leakage, the air system can be switched off in order to avoid damage to the at least one fuel cell.

Additionally, the diagnostic function can be used in order to detect a hose collapse upstream of the air compressor. Indications for the latter are a low negative pressure at the inlet of the air compressor as well as the associated low pressure difference Δp across the air filter. This can be due not only to a clogged air filter, but also to a clogged air path, for example by deliberate insertion of objects into the air path. Furthermore, a hose collapse can occur due to material fatigue.

In the further development of the invention, it is proposed that, in order to ascertain the present pressure difference Δp, the ambient pressure p_{U} as well as the pressure p_{FiltDs} in the air path downstream of the air filter and upstream of the air compressor are measured. The pressure difference Δp can then be calculated according to the following formula:

$$Δ p = {p}_{U} - {p}_{FiltDs}$$

During the operation of the air compressor, ambient air is drawn into the air filter, wherein the pressure upstream of the air filter corresponds to the ambient pressure p_{U}. If the air compressor is operated at a rotational speed greater than zero, the pressure downstream of the air filter drops to the pressure p_{FiltDs}. In the present case, the difference Δp between the two pressures serves as a measure of the filter loading.

The pressure measurement is preferably carried out by means of an ambient pressure sensor and a further pressure sensor integrated into the air path downstream of the air filter and upstream of the air compressor. If corresponding pressure sensors are already present, they can be used for pressure measurement. Alternatively or additionally, a hot film air mass sensor (HFM) can be used, which detects the pressure, temperature, and mass flow in the air path.

Furthermore, it is proposed that, when diagnosing the air filter, the mass flow rate and/or the flow rate upstream of the air compressor be considered. By considering the mass flow rate and/or the volumetric flow rate upstream of the air compressor, the accuracy of the diagnostic result can be increased. This applies in particular to the consideration of the volumetric flow rate. This is because the pressure difference Δp across the air filter increases with increasing volumetric flow rate upstream of the air compressor, as the sucking in of ambient air causes a negative pressure upstream of the air compressor.

If an HFM is used in order to detect the pressure in the incoming air path, the volumetric flow rate vf_{FiltDs} can be calculated from the measured values of the HFM according to the following equation:

$${Vf}_{FiltDs} = {mf}_{Filt} \times R \times \frac{{t}_{FiltDs}}{{p}_{FiltDs}}$$

wherein
mf_{Filt} the mass flow measured downstream of the air filter,
t_{FiltDs} the temperature measured downstream of the air filter,
p_{FiltDs} the pressure measured downstream of the air filter
and wherein the specific gas constant for air is R=287 J/kgK.

Preferably, in order to ascertain an excessively high loading of the air filter, the present pressure difference Δp is compared to a volumetric flow-dependent characteristic curve Δp(vf_{FiltDs}) as the maximum permissible pressure difference. By comparing the present pressure difference Δp to the volumetric flow-dependent characteristic curve Δp(vf_{FiltDs}), it can be precisely determined whether the loading of the air filter is in a critical range or not. The volumetric flow-dependent characteristic curve Δp(vf_{FiltDs}) is preferably ascertained in advance and stored in a memory unit, for example in a memory unit of a control unit of the fuel cell system.

If the volumetric flow-dependent characteristic curve (Δpvf_{FiltDs}) is exceeded, which indicates an over-loaded air filter, it is preferable to carry out a shutdown of the system in order to protect the system.

Early detection can be carried out by means of an application below the volumetric flow-dependent characteristic curve Δp(vf_{FiltDs}). This indicates when the next filter change is due, so that it can be scheduled and carried out in a timely manner. In mobile fuel cell systems, a pending filter change can be displayed via a display in the cockpit.

Further preferably, a minimum permissible pressure difference is defined and stored in a memory unit. It is preferably detected by comparing the present pressure difference Δp to the minimum permissible pressure difference stored in the memory unit whether the air filter has been impermissibly removed and/or a leak has arisen in the air path between the air filter and the air compressor. This is the case when the minimum permissible value is undershot. In response, the air and/or fuel cell system is further preferably switched off in order to protect the system.

Preferably, in order to determine the degree of loading of the air filter, a percentage characteristic value x_{Filt} is ascertained according to the following equation:

$${x}_{Filt} = \frac{{p}_{U} - {p}_{FiltDs}}{Δ {p}_{ma x} ( v {f}_{FiltDs} )} \times 100 \%$$

wherein
Δpₘₐₓ(vf_{FiltDs}) is the volumetric flow-dependent maximum pressure difference.

In principle, the lower the volumetric flow rate, the lower the pressure difference Δp. This means that, at low volumetric flow rates, the loading of the air filter can be detected less well than at high volumetric flow rates. Therefore, in order to increase the accuracy in determining the degree of loading of the air filter, it is further proposed that the diagnosis of the air filter is carried out only at sufficiently high volumetric flow rates in the air path.

As a further developing measure, it is therefore proposed that a minimum value vf_{FiltDs,lim} for the permissibility of carrying out the diagnosis of the air filter is defined, and the diagnosis is only carried out if the following condition is met:

$${vf}_{FiltDs} > {vf}_{FiltDs , l im}$$

The minimum value vf_{FiltDs,lim} depends in particular on the type of air filter.

In order to further increase the accuracy of the air filter diagnosis, it is proposed that the temperature and/or moisture of the ambient air be ascertained upstream of the air compressor and considered during the diagnosis of the air filter. For this purpose, a temperature and/or a moisture sensor is preferably integrated into the air path.

In addition, a control unit that is configured so as to carry out steps of a method according to the invention is proposed. For this purpose, in the control unit or in a memory unit of the control unit, a volumetric flow-dependent characteristic curve Δp(vf_{FiltDs}) can be stored as the maximum permissible pressure difference. Alternatively or additionally, a minimum permissible pressure difference can be stored in the control unit or in a memory unit of the control unit. The control unit can then be used in order to compare the ascertained present pressure difference Δp to the respective stored values.

### BRIEF DESCRIPTION OF THE DRAWINGS

The invention and its advantages are explained in further detail below with reference to the accompanying drawing. It shows a schematic representation of an air system that can be operated according to the method according to the invention.

### DETAILED DESCRIPTION

The illustrated air system 1 serves to supply air to at least one fuel cell (not shown) as an oxygen provider. The air is removed from the surroundings for this purpose and fed to the at least one fuel cell via an air path 2 of the air system 1.

An air filter 3 and an air compressor 4 are integrated in the air path 2. With the aid of the air filter 3, chemicals and particles contained in the ambient air are removed. With the aid of the air compressor 4, the air is drawn from the surroundings and compressed. The compression takes place after the purification of the ambient air so that pre-purified air is supplied to the air compressor 4.

In the air path 2, upstream of the air filter 3, the ambient pressure p_{U} prevails. Downstream of the air filter 3 and upstream of the air compressor 4, a pressure p_{FiltDs} prevails, which is measured by means of a sensor (not shown), in particular a pressure sensor, a pressure and temperature sensor, and/or a hot film air mass sensor (HFM). If the latter is the case, the temperature t_{FiltDs} as well as the mass flow m_{FiltDs} can also be ascertained by means of a sensor.

Knowing the ambient pressure p_{U} and the pressure p_{FiltDs} downstream of the air filter, the pressure difference Δp can be ascertained via the air filter 3. From the present pressure difference Δp, it can then be derived whether the loading of the air filter has reached a critical range and may need to be replaced. The ascertained present pressure difference can in particular be compared to a volumetric flow-dependent characteristic curve that defines a maximum permissible pressure difference. The characteristic curve can be stored in a memory unit, in particular in a memory unit of a control unit (not shown). The comparison can then be carried out by means of the control unit. If the comparison shows that the present pressure difference has a value above the characteristic curve, this is indicative of an air filter that is so heavily loaded that the system must be switched off immediately. In order to prevent exceeding the characteristic curve, an application below the characteristic curve can be used for early detection. This ensures that the filter replacement or removal is done in a timely manner.

When carrying out the diagnosis of the air filter 3, the volumetric flow rate in the air path upstream of the air compressor 4 is therefore considered, in particular. Alternatively or in addition to the volumetric flow rate, the mass flow rate, the temperature, and/or the moisture of the air in air path 2 can be considered.

1. A method for operating an air system (1) for supplying oxygen to at least one fuel cell, wherein the air system (1) comprises an air path (2) having an integrated air filter (3) and an integrated air compressor (4), and wherein ambient air is drawn in by means of the air compressor (4), purified by means of the air filter (3), and compressed by means of the air compressor (4) before being fed as an oxygen source to the fuel cell,
wherein a diagnosis of the air filter (4) is carried out during the operation of the air system (1) and is used for
detecting excessively high loading of the air filter (3),
determining a degree of loading of the air filter (3),
detecting unauthorized removal of the air filter (3),
detecting a leak in the air path (2) upstream of the air compressor (4), and/or
detecting a hose collapse,
wherein a present pressure difference (Δp) across the air filter (3) is ascertained, and the loading of the air filter (3) is inferred from the present pressure difference (Δp).

2. The method according to claim 1,
wherein in order to ascertain the present pressure difference (Δp), the ambient pressure (p_{U}) as well as the pressure in the air path (2) downstream of the air filter (3) and upstream of the air compressor (4) is measured.

3. The method according to claim 1,
wherein during the diagnosis of the air filter (3), a mass flow rate and/or a volumetric flow rate upstream of the air compressor (4) is considered.

4. The method according to claim 1,
wherein in order to ascertain an excessively high loading of the air filter (3), the present pressure difference (Δp) is compared to a volumetric flow-dependent characteristic curve (Δp(vf_{FiltDs})) as a maximum permissible pressure difference.

5. The method according to claim 4,
wherein the volumetric flow-dependent characteristic curve (Δp(vf_{FiltDs})) is ascertained in advance as the maximum permissible pressure difference and is stored in a memory unit.

6. The method according to claim 1,
wherein a minimum permissible pressure difference is defined and stored in a memory unit, wherein it is detected by comparing the present pressure difference (Δp) to the minimum permissible pressure difference stored in the memory unit whether the air filter has been impermissibly removed and/or a leak has arisen in the air path between the air filter and the air compressor.

7. The method according to claim 1,
wherein in order to determine the degree of loading of the air filter (3), a percentage characteristic value (x_{Filt}) is ascertained according to the following equation:
$${x}_{Filt} = \frac{{p}_{U} - {p}_{FiltDs}}{Δ {p}_{ma x} ( v {f}_{FiltDs} )} \times 100 \%$$
wherein
Δpₘₐₓ(vf_{FiltDs}) is the volumetric flow-dependent maximum pressure difference.

8. The method according to claim 1,
wherein a minimum value (vf_{FiltDs,lim}) for a permissibility of carrying out the diagnosis of the air filter (3) is defined, and the diagnosis is only carried out if the following condition is met:
$${vf}_{FiltDs} > {vf}_{FiltDs , l im}$$

9. The method according to claim 1,
wherein a temperature and/or moisture of the ambient air is ascertained upstream of the air compressor (4) and considered in the diagnosis of the air filter (3).

10. A control unit configured to operate an air system (1) for supplying oxygen to a fuel cell, wherein the air system (1) comprises an air path (2) having an integrated air filter (3) and an integrated air compressor (4), and wherein ambient air is drawn in by means of the air compressor (4), purified by means of the air filter (3), and compressed by means of the air compressor (4) before being fed as an oxygen source to the fuel cell,
wherein a diagnosis of the air filter (4) is carried out during the operation of the air system (1) and is used for
detecting excessively high loading of the air filter (3),
determining a degree of loading of the air filter (3),
detecting unauthorized removal of the air filter (3),
detecting a leak in the air path (2) upstream of the air compressor (4), and/or detecting a hose collapse,
wherein a present pressure difference (Δp) across the air filter (3) is ascertained, and the loading of the air filter (3) is inferred from the present pressure difference (Δp).
